(19) United States
(12) Patent Application Publication
(10) Pub. No.: US 2020/0022477 A1
(43) Pub. Date: Jan. 23, 2020

(54) SKIN CARE MASK PACK FOR NAIL ART AND MANUFACTURING METHOD THEREFOR

(71) Applicants: Sung Yeong YUN, Seoul (KR); THE NAMIE CO., LTD, Gunpo-si, Gyeonggi-do (KR)

(72) Inventor: Sung Yeong YUN, Seoul (KR)

(73) Assignees: THE NAMIE CO., LTD., Gunpo-si, Gyeonggi-do (KR); Sung Yeong YUN, Gunpo-si, Gyeonggi-do (KR)

(21) Appl. No.: 16/483,362

(22) PCT Filed: Feb. 3, 2017
(86) PCT No.: PCT/KR2017/001169

§ 371 Date: Aug. 2, 2019

(30) Foreign Application Priority Data
Feb. 3, 2017 (KR) 10-2017-0015293

(51) Int. Cl. A45D 29/00

(52) U.S. Cl. CPC A45D 29/004; B32B 5/04

(57) ABSTRACT

A skin care mask pack for nail art includes a mask pack fabric layer having a peripheral mask region patterned to cover the skin around a nail and a skin care-adhesive mixed layer obtained by mixing a liquid adhesive and one or more skin care materials and applying the resulting mixture to one side of the mask pack fabric layer. The skin care mask pack can cover the skin around a nail after the cuticle is removed, to protect the skin from external damage. Also, in a curing process which is one step of a gel nail procedure, the skin care mask pack can block ultraviolet radiation from reaching the skin around a nail, to prevent the skin from being damaged. The mask pack can also prevent the skin around the nail from being smeared with liquid gel in the process of applying the liquid gel to the nail.

### TECHNICAL FIELD

The present invention relates to a mask pack for skin care, and more particularly, to a skin care mask pack for nail art to care skin around finger and toe nails.

### BACKGROUND ART

Gel nail is a kind of nail art that has recently been spotlighted. A process of applying the gel nail onto a finger nail is briefly described as follows. First, after a pretreatment process such as removal of cuticle, a gel solution is applied onto the finger nail. Then, a curing process of curing the gel solution applied onto the finger nail is performed by using an ultraviolet lamp. Depending on a type of the gel nail, the process of applying and curing various types of gel solutions may be repeated several times.

However, the skin around the nail from which the cuticle is removed may be easily damaged. Repeated cuticle removal and gel nail procedures may cause damage to the skin around the nail. In addition, in the repeated curing process, the skin around the nail may be discolored with black when exposed to ultraviolet rays repeatedly.

Meanwhile, the gel nail procedure as described above is a difficult task for the general public. When liquid gel for the gel nail is applied onto the nail, the skin around the nail may be smeared with the liquid gel. After the curing, the cured gel smeared onto the skin may be easily peeled off. At this time, a shape of the gel nail may be damaged while the gel nail is separated from the gel applied and cured on the nail.

### DETAILED DESCRIPTION OF THE INVENTION

### Technical Problem

An object of the present invention is to provide a skin care mask pack for nail art to protect skin around a nail from external damage to which the skin may be vulnerable after cuticle is removed.

Another object of the present invention is to provide a skin care mask pack for nail art, which is capable of blocking ultraviolet rays from being irradiated to the skin around the nail in a curing process to prevent the skin around the nail from being damaged.

Still another object of the present invention is to provide a skin care mask pack for nail art, capable of protecting the skin around the nail during a gel nail procedure, and facilitating the gel nail procedure.

### Technical Solution

To achieve the objects described above, according to one aspect of the present invention, there is provided a skin care mask pack for nail art.

The skin care mask pack for the nail art of the present invention includes: a mask pack fabric layer having a peripheral mask region patterned to cover skin around a nail; and a skin care-adhesive mixed layer obtained by mixing a liquid adhesive and at least one skin care material and applying a resulting mixture to one side of the mask pack fabric layer.

In an embodiment, the mask pack fabric layer may have a water permeable structure.

In an embodiment, the mask pack fabric layer may have an elastic structure which is stretchable and extendable.

In an embodiment, the skin care mask pack may include an ultraviolet blocking layer formed on an opposite side of the mask pack fabric layer or between the mask pack fabric layer and the skin care-adhesive mixed layer.

In an embodiment, the mask pack fabric layer may include an extended mask region extending from the peripheral mask region.

In an embodiment, the skin care mask pack may include: at least one temporary mask pack fabric layer stacked and attached to an opposite side of the mask pack fabric layer; and an adhesive layer applied to one side of the temporary mask pack fabric layer which is stacked on the mask pack fabric layer.

According to another aspect of the present invention, there is provided a method of manufacturing a skin care mask pack for nail art. The method of manufacturing the skin care mask pack for the nail art of the present invention includes: preparing a skin care-adhesive mixed solution by mixing a liquid adhesive and at least one skin care material; preparing a release paper and a mask pack fabric; applying the skin care-adhesive mixed solution to one side of the mask pack fabric; attaching the mask pack fabric to the release paper by allowing the one side of the mask pack fabric to which the skin care-adhesive mixed solution is applied to face the release paper; mask pattern processing to form a mask pattern configured to have a structure for covering skin around a nail on the mask pack fabric; and simultaneously cutting the release paper and the mask pack fabric.

In an embodiment, the mask pack fabric may be composed of a fabric having a single layer structure with one layer or a fabric having a multilayer structure in which at least two layers are adhered to each other.

### Advantageous Effects of the Invention

The skin care mask pack for the nail art according to the present invention can cover the skin around the nail after the cuticle is removed so as to protect the skin around the nail from the external damage to which the skin may be vulnerable due to the removal of the cuticle. In addition, in the curing process which is one step of the gel nail procedure, the skin care mask pack can block the ultraviolet rays from being irradiated to the skin around the nail so as to prevent the skin around the nail from being damaged. Further, the skin care mask pack can protect the skin around the nail, and prevent the skin around the nail from being smeared with liquid gel in a process of applying the liquid gel onto the nail. Therefore, the present invention can improve the quality of the gel nail procedure.

### DESCRIPTION OF THE DRAWINGS

FIG. 1 is a view illustrating fingers before and after cuticle on a finger nail is removed from the finger nail.

FIG. 2 is a view illustrating a scheme of attaching a skin care mask pack for nail art onto skin around a finger nail according to an exemplary embodiment of the present invention.

FIG. 3 is a sectional view for describing a hierarchical structure of the skin care mask pack according to a first embodiment of the present invention.

FIGS. 4 and 5 are views illustrating various modified examples of the skin care mask pack of the present invention.

FIG. 6 is a flowchart sequentially illustrating a process of performing a gel nail procedure by using the skin care mask pack of the present invention.

FIG. 7 is a sectional view illustrating a modified example in which an ultraviolet blocking layer is added to the skin care mask pack of the present invention.

FIG. 8 is a view illustrating a hierarchical structure of the skin care mask pack according to a second embodiment of the present invention.

FIG. 9 is a flowchart sequentially illustrating the process of performing the gel nail procedure by using the skin care mask pack of FIG. 8.

FIG. 10 is a flowchart sequentially illustrating a process of manufacturing a skin care mask pack of the present invention.

### BEST MODE

In order to fully understand the present invention, an exemplary embodiment of the present invention will be described with reference to the accompanying drawings. Embodiments of the present invention may be modified or applied in various forms. Thus, the exemplary embodiment of the present invention is not intended to limit the prevent invention to a particular form. In other words, it is to be understood that modifications within the fundamental intent and technical scope of the present invention and substitutions of equivalent without departing from the intent fall within the scope of the present invention. The embodiments of the present invention are provided so that those of ordinary skill in the art to which the present invention pertains may easily understand the present invention. The drawings presented in the embodiments of the present invention may be exaggerated or omitted as compared with actual implementations. In the drawings, it should be noted that like elements may be denoted by like reference numerals. In addition, the detailed descriptions of well-known functions and configurations may be omitted when they are determined to unnecessarily obscure the gist of the present invention. Hereinafter, the present invention will be described in detail with reference to the accompanying drawings.

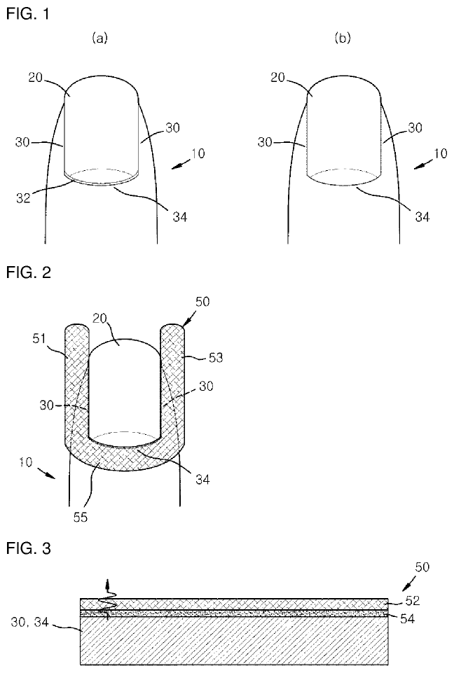

FIG. 1 is a view illustrating fingers before and after cuticle on a finger nail is removed from the finger nail, and FIG. 2 is a view illustrating a case in which a skin care mask pack for nail art is attached onto skin around a finger nail according to an exemplary embodiment of the present invention.

Referring to FIGS. 1 and 2, in general, a cuticle 32 is removed before a gel nail procedure. FIGS. 1(a) and 1(b) show states before and after the cuticle 32 is removed, respectively. After the cuticle 32 is removed, a finger nail rear skin 34 becomes vulnerable to external damage. Therefore, as shown in FIG. 2, a skin care mask pack 50 is attached onto a finger 10 from which the cuticle 32 is removed so as to cover a finger nail side skin 30 and the finger nail rear skin 34 which are skins around a nail 20. In order to cover the finger nail side skin 30 and the finger nail rear skin 34, the skin care mask pack 50 may have a mask pattern with a peripheral mask region configured to have a ‘U’ shape. In other words, the skin care mask pack 50 has the mask pattern configured to have a ‘U’ shape, so that two mask pack side end portions 51 and 53 may cover the finger nail side skin 30 on both sides of a finger nail 20, and a mask pack rear end portion 55 may cover the finger nail rear skin 34 from which the cuticle 32 is removed.

Since the gel nail procedure is performed in a state where the skin care mask pack 50 is attached, the finger nail rear skin 34 which is sensitive due to the removal of the cuticle 34 can be protected. In addition, since the finger nail side skin 30 as well as the finger nail rear skin 34 are covered by the skin care mask pack 50, skin around a finger nail is prevented from being directly exposed to ultraviolet rays in a subsequent curing process which is an ultraviolet curing process, so that the skin around the finger nail can be prevented from being damaged due to the ultraviolet rays. Further, even when liquid gel is applied, the liquid gel may be prevented from being applied onto the skin around the finger nail by the skin care mask pack 50, so that the quality of the gel nail procedure can be improved. Therefore, ordinary people as well as nail art experts can perform a high-quality gel nail procedure by using the skin care mask pack.

FIG. 3 is a sectional view for describing a hierarchical structure of the skin care mask pack according to a first embodiment of the present invention.

Referring to FIG. 3, the skin care mask pack 50 according to the first embodiment of the present invention includes a mask pack fabric layer 52 and a skin care-adhesive mixed layer 54 adhered to one side of the mask pack fabric layer 52. The skin care-adhesive mixed layer 54 is obtained by mixing a liquid adhesive and at least one skin care material and applying a resulting mixture to the one side of the mask pack fabric layer 52. A fabric used as the mask pack fabric layer 52 preferably has a water permeable structure. In addition, the fabric used as the mask pack fabric layer 52 preferably has an elastic structure which is stretchable and extendable. In order for the mask pack fabric layer 52 to have such functions, spandex, which is one of functional fabrics, may be used.

The skin care-adhesive mixed layer 54 is obtained by mixing the liquid adhesive and the at least one skin care material. As the skin care material, for example, at least one of a moisturizing agent, a whitening agent, and a nutritional ingredient such as vitamin may be used.

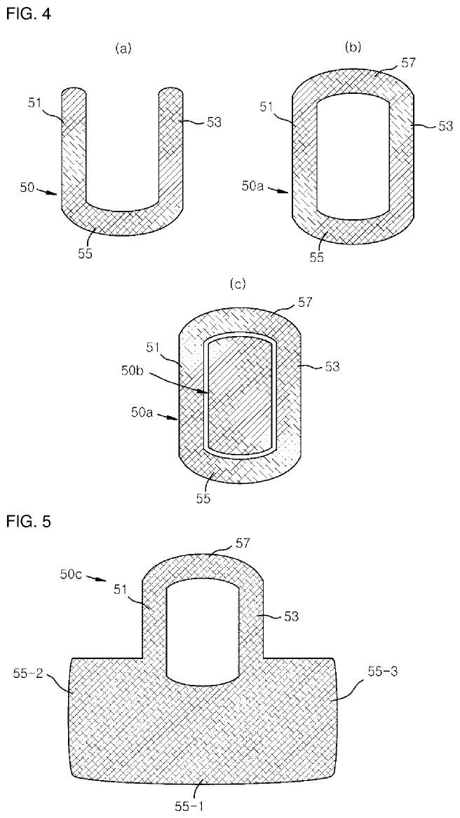

FIGS. 4 and 5 are views illustrating various modified examples of the skin care mask pack of the present invention.

As shown in FIG. 4(a), the skin care mask pack 50 according to an example may configured to have a ‘U’-shaped mask pattern. As shown in FIG. 4(b), a skin care mask pack 50a according to another example may include two mask pack side end portions 51 and 53 and a mask pack front end portion 57 to which one ends of the two mask pack side end portions 51 and 53 are connected, so that the skin care mask pack 50a may configured to have a mask pattern having an ‘0’ shape on the whole. When the skin care mask pack 50a is manufactured as a commercial product, a band-shaped skin care mask pack 50b may be provided in an inner hollow region of the ‘U’-shaped skin care mask pack 50a.

Referring to FIG. 5, a skin care mask pack 50c according to still another example may configured to have a mask pattern having an extended mask region including a mask pack rear end extension portion 55-1 and mask pack side end wing portions 55-2 and 55-3. In other words, the extended mask region extending from the peripheral mask region which includes the mask pack side end portions 51 and 53 and the mask pack rear end portion 55 may be provided. Such an extended mask region may longitudinally cover the finger by the mask pack rear end extension portion 55-1, and may wrap the finger by the mask pack side end wing portions 55-2 and 55-3, so that a wide area of finger skin may be protected during the curing process.

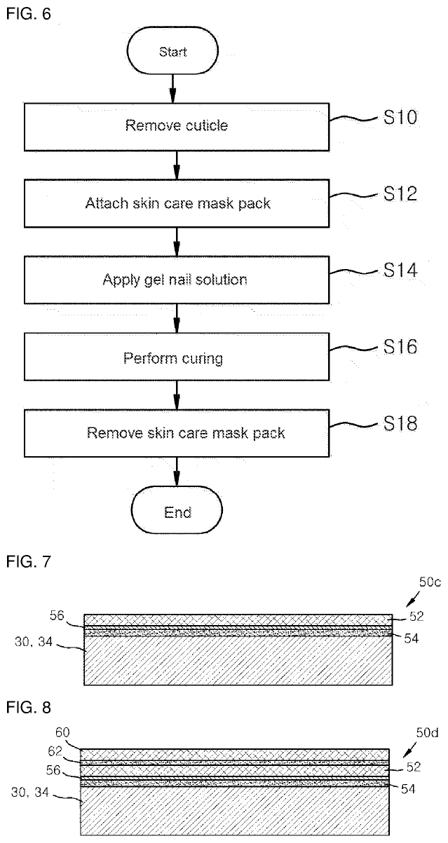

FIG. 6 is a flowchart sequentially illustrating a process of performing a gel nail procedure by using the skin care mask pack of the present invention.

Referring to FIG. 6, in step S10, a cuticle removal process is performed for the gel nail procedure. In step S12, the skin care mask pack is attached so as to cover the skin around the nail from which the cuticle is removed. In step S14, a gel solution is applied onto the nail while the skin care mask pack is attached. Next, in step S16, the curing process of curing the gel solution applied onto the nail by irradiating the ultraviolet rays onto the gel solution is performed. When the curing process is completed, in step S18, the gel nail procedure is completed as the skin care mask pack is removed.

As described above, the skin care mask pack for the nail art according to the present invention can cover the skin around the nail after the cuticle is removed so as to protect the skin around the nail from the external damage to which the skin may be vulnerable due to the removal of the cuticle. In addition, in the curing process which is one step of the gel nail procedure, the skin care mask pack can block the ultraviolet rays from being irradiated to the skin around the nail so as to prevent the skin around the nail from being damaged. Further, the skin care mask pack can protect the skin around the nail, and prevent the skin around the nail from being smeared with liquid gel in a process of applying the liquid gel onto the nail. Therefore, ordinary people as well as nail art experts can perform a high-quality gel nail procedure by using the skin care mask pack.

FIG. 7 is a sectional view illustrating a modified example in which an ultraviolet blocking layer is added to the skin care mask pack of the present invention.

Referring to FIG. 7, the skin care mask pack 50c according to still another modified example may additionally include an ultraviolet blocking layer 56 to prevent the ultraviolet rays from being transmitted through the skin care mask pack 50c. The ultraviolet blocking layer 56 may be added between the mask pack fabric layer 52 and the skin care-adhesive mixed layer 54. Alternatively, the ultraviolet blocking layer 56 may be formed on an opposite side of the mask pack fabric layer 52. The skin care mask pack 50c having such a configuration may further prevent the ultraviolet rays from being irradiated onto the skin by passing through air-permeable holes of the mask pack fabric layer 52 during the curing process.

FIG. 8 is a view illustrating a hierarchical structure of the skin care mask pack according to a second embodiment of the present invention.

Referring to FIG. 8, in a skin care mask pack 50d according to the second embodiment of the present invention, a temporary mask pack fabric layer 60 is attached to an opposite side, that is, an upper side of the mask pack fabric layer 52. The temporary mask pack fabric layer 60 is attached to the mask pack fabric layer 52 by an adhesive layer 62.

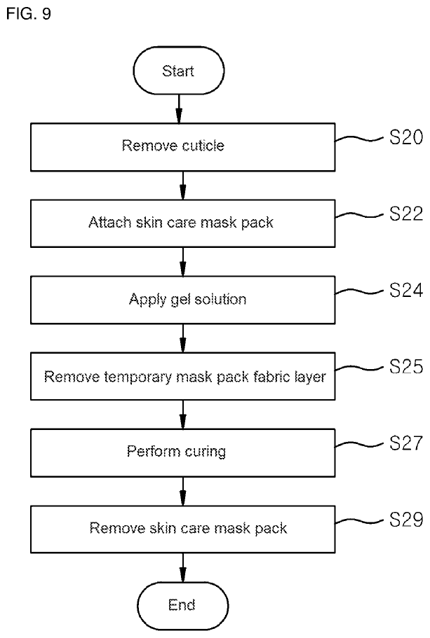

FIG. 9 is a flowchart sequentially illustrating the process of performing the gel nail procedure by using the skin care mask pack of FIG. 8.

Referring to FIG. 9, in the process of performing the gel nail procedure by using the skin care mask pack 50d according to the second embodiment of the present invention, in step S20, a cuticle removal process is performed for the gel nail procedure, and in step S22, the skin care mask pack 50d is attached so as to cover the skin around the nail from which the cuticle is removed. In addition, in step S24, the gel solution is applied onto the nail while the skin care mask pack 50d is attached.

In a process of applying the gel solution, the skin care mask pack 50d may be smeared with the gel solution. Thus, in step S25, only the temporary mask pack fabric layer 60 is removed from the skin care mask pack 50d. In addition, in step S27, the curing process of curing the gel solution applied onto the nail by irradiating the ultraviolet rays onto the gel solution is performed. When the curing process is completed, in step S29, the gel nail procedure is completed as the skin care mask pack 50d is removed.

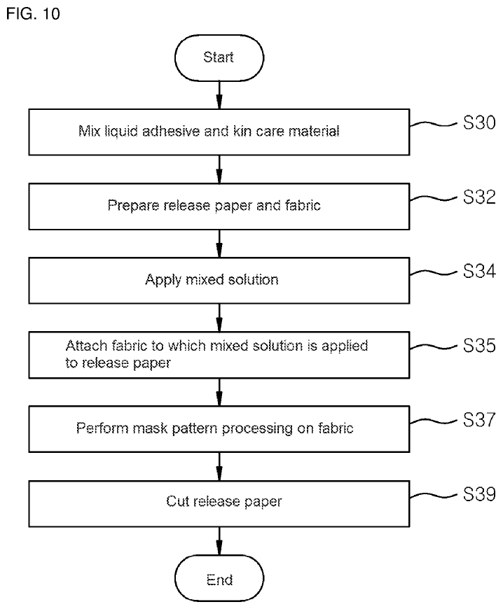

FIG. 10 is a flowchart sequentially illustrating a process of manufacturing a skin care mask pack of the present invention.

Referring to FIG. 10, the skin care mask pack of the present invention is manufactured by the following manufacturing method. First, in step S30, a skin care-adhesive mixed solution is prepared by mixing the liquid adhesive and at least one skin care material. In step S32, a release paper and a mask pack fabric are prepared. In step S34, the skin care-adhesive mixed solution is applied to one side of the mask pack fabric. A scheme of applying the skin care-adhesive mixed solution may be implemented by a roller coating scheme, a spray injection scheme, or the like. After the skin care-adhesive mixed solution is applied, a drying process may be performed by a scheme such as natural drying or heat drying.

Next, in step S35, the mask pack fabric is attached to the release paper by allowing the one side of the mask pack fabric to which the skin care-adhesive mixed solution is applied to face the release paper. In step S37, mask pattern processing to form a mask pattern configured to have a structure for covering skin around a nail on the mask pack fabric is performed. The mask pattern processing may be performed, for example, by Thomson processing. In addition, in step S39, the release paper and the mask pack fabric are simultaneously cut, thereby completing the process of manufacturing the skin care mask pack.

As described above, the mask pack fabric may be composed of a fabric having a single layer structure with one layer or a fabric having a multilayer structure in which at least two layers are adhered to each other. The fabric having the multilayer structure may be manufactured through a separate manufacturing process, or the multilayer fabric may be formed in the process of manufacturing the skin care mask pack. The multilayer structure may be composed of at least two layers. During the gel nail procedure, in a process of applying the liquid at least two times and performing the curing process at least two times, the temporary mask pack fabric layer may be removed one layer at a time.

### DESCRIPTION OF REFERENCE NUMERALS

10: Finger, 20: Finger nail, 30: Finger nail side skin, 32: Cuticle, 34: Finger nail rear skin, 50, 50a, 50b, 50c: Skin care mask pack, 51, 53: Mask pack side end portion, 52: Mask pack fabric layer, 54: Skin care-adhesive mixed layer, 55: Mask pack rear end portion, 57: Mask pack front end portion, 55-1: Mask pack rear end extension portion, 55-2, 55-3: Mask pack side end wing portion, 56: Ultraviolet blocking layer, 60: Temporary mask pack fabric layer, 62: Adhesive layer

1. A skin care mask pack comprising:
a mask pack fabric layer having a peripheral mask region patterned to cover skin around a nail; and
a skin care-adhesive mixed layer obtained by mixing a liquid adhesive and at least one skin care material and applying a resulting mixture to one side of the mask pack fabric layer.

2. The skin care mask pack of claim 1, wherein the mask pack fabric layer has a water permeable structure.

3. The skin care mask pack of claim 1, wherein the mask pack fabric layer has an elastic structure which is stretchable and extendable.

4. The skin care mask pack of claim 1, further comprising an ultraviolet blocking layer formed on an opposite side of the mask pack fabric layer or between the mask pack fabric layer and the skin care-adhesive mixed layer.

5. The skin care mask pack of claim 1, wherein the mask pack fabric layer includes an extended mask region extending from the peripheral mask region.

6. The skin care mask pack of claim 1, further comprising:
at least one temporary mask pack fabric layer stacked and attached to an opposite side of the mask pack fabric layer; and
an adhesive layer applied to one side of the temporary mask pack fabric layer which is stacked on the mask pack fabric layer.

7. A method of manufacturing a skin care mask pack, the method comprising:
preparing a skin care-adhesive mixed solution by mixing a liquid adhesive and at least one skin care material;
preparing a release paper and a mask pack fabric;
applying the skin care-adhesive mixed solution to one side of the mask pack fabric;
attaching the mask pack fabric to the release paper by allowing the one side of the mask pack fabric to which the skin care-adhesive mixed solution is applied to face the release paper;
mask pattern processing to form a mask pattern configured to have a structure for covering skin around a nail on the mask pack fabric; and
simultaneously cutting the release paper and the mask pack fabric.

8. The method of claim 7, wherein the mask pack fabric is composed of a fabric having a single layer structure with one layer or a fabric having a multilayer structure in which at least two layers are adhered to each other.
